(19) United States
(12) Patent Application Publication
(10) Pub. No.: US 2007/0122062 A1
(43) Pub. Date: May 31, 2007

(54) Method and system for processing employment related images

(75) Inventor: Eric Jacobs, Lansing, KS (US)

Correspondence Address: HOVEY WILLIAMS LLP, 2405 GRAND BLVD., SUITE 400, KANSAS CITY, MO, 64108, US

(73) Assignee: ADsnitch.com

(21) Appl. No.: 11/290,315

(22) Filed: Nov. 30, 2005

(51) Int. Cl. G06K 9/54

(52) U.S. Cl. 382/305

(57) ABSTRACT

A method and computer program enable the electronic capture and archiving of portions of printed publications for electronic searching and retrieval via a computer network. Employment-related sections of a plurality of printed publications are scanned to create a master digital image for each publication. Each master image is surveyed by an operator to identify locations of individual articles and advertisements contained in the image. A plurality of specific images are created from each master image, wherein each specific image contains a single article or advertisement. An operator defines a category, subcategory, and geographic location of each specific image, and each image is processed by optical character recognition software to determine text contained in the image. An end user searches the articles and advertisements according to category, subcategory, geographic location, and text, and views each specific image matching the user's search.

### BACKGROUND OF THE INVENTION

1. Field of the Invention

The present invention relates to electronically storing articles and advertisements that appear in printed publications. More particularly, the present invention involves a method and computer program for electronically capturing and archiving portions of printed publications for electronic searching and retrieval via a computer network.

2. Description of Prior Art

Professional recruiters and individuals seeking employment gather information relating to companies and employment opportunities within those companies from various sources. Individual job seekers use such information to identify desirable positions and to contact the employers offering those positions. Professional recruiters use the information to identify potential clients and to gather the information necessary to initiate relationships with the potential clients. Unfortunately, useful employment-related information often escapes the searches of recruiters, job seekers, and others who would benefit therefrom because it is made available only in a form or a location that is not readily accessible by those seeking it.

While some employment-related information is available in electronic form, printed publications are one of the best sources of employment-related information. Printed publications that typically include employment-related information include newspapers, magazines, research and trade journals, and similar printed materials. Much of the information included in such printed publications, however, is not available in electronic form, and therefore must be reviewed manually to identify relevant information. Unfortunately, the sheer volume of potentially relevant printed information precludes a timely and comprehensive review of the information. Furthermore, the printed publications that contain this information are printed in geographically disperse locations, making it difficult to identify and collect copies in a timely manner. These challenges are exacerbated by the time-intensive nature of job seeking and recruiting, wherein receiving the employment-related information in a timely manner can give a competitive edge to a job applicant or to a recruiter seeking to identify a new client or a new need of an existing client.

Printed publications are not only difficult to obtain and review comprehensively, as explained above, but certain publications may contain little or no information that is of interest to a particular individual who is seeking a particular type of employment opportunity. Therefore, even if job seekers and recruiters take time to read through printed publications, much of the time would be wasted reviewing irrelevant information.

Accordingly, there is a need for an improved method of reviewing articles and advertisements of printed publications that overcomes the limitations of the prior art.

### SUMMARY OF THE INVENTION

The present invention provides an improved method of cataloging printed articles and advertisements that does not suffer from the problems and limitations of the prior art. Particularly, the present invention provides a method and computer program for electronically capturing and archiving portions of printed publications for electronic searching and retrieval via a computer network.

In a first embodiment, the invention is a computer-readable medium encoded with a computer program for enabling a computer to perform a method of processing images of printed publications. The method comprises various steps, including the steps of scanning a printed publication to create a first digital image of a portion of the publication, receiving location information from a user identifying a location of an article or advertisement in the digital image, and creating a second digital image from the first digital image, wherein the second digital image corresponds to a portion of the first digital image defined by the location information. The second digital image is processed to generate text data corresponding to text contained in the second image, and the text data is associated with the second image and stored along with the second image in a database. Finally, the second image is presented to a user if the text data matches a search parameter submitted by a user.

A second embodiment of the invention is a method of electronically archiving employment-related information from a plurality of printed publications. The method comprises various steps, including the steps of reviewing each of the printed publications to identify relevant portions containing employment-related information, electronically scanning the relevant portions of each of the printed publications to create at least one master digital image associated with each publication, and surveying each master digital image to identify coordinates corresponding to one or more employment-related articles or advertisements contained in the image.

A plurality of specific images are created from each master image, wherein each specific image corresponds to a single article or advertisement defined by the coordinates. Each specific image is processed using a computer to generate text data corresponding to text contained in the specific image, and the text data is associated with the specific image from which it was generated and stored along with the specific images in a database. Finally, a specific image is presented to a user if the text data corresponding to the specific image corresponds to a search parameter submitted by a user.

A third embodiment of the invention is a computer-readable medium encoded with a computer program for enabling a computer to process images of printed publications. The computer program comprises various routines, including a scanning routine for generating a new master image of a printed publication by scanning a portion of the printed publication and an image enhancing routine for processing the new master image to generate an enhanced master image that is more easily read by a person and more easily processed by a computer. The image enhancing routine also stores the enhanced image in a digital storage medium.

A crop coordinates routine presents the master digital image to a user and receives coordinate information from the user identifying a plurality of articles or advertisements contained in the master image. A crop image routine generates a specific image corresponding to the plurality of articles or advertisements contained in the master image according to the coordinate information, and a character recognition routine generates text data corresponding to text contained in the specific image and associates the text data with the specific image from which it was generated.

A workflow routine directs the various other routines to route the initial scanned image through various processing steps. The workflow routine automatically communicates the new master image generated by the scanning routine to the image enhancing routine; communicates the enhanced image to the crop coordinates routine; communicates the enhanced image and the coordinate information to the crop image routine; communicates the specific image generated by the crop image routine to the text processing routine; and stores the specific image and the associated text data generated by the character recognition routine in a searchable database.

These and other important aspects of the present invention are described more fully in the detailed description below.

### BRIEF DESCRIPTION OF THE DRAWINGS

A preferred embodiment of the present invention is described in detail below with reference to the attached drawing figures, wherein:

FIG. 1 is an exemplary computer network for implementing a computer program of the present invention;

FIG. 2 is a flowchart of steps involved in a method of electronically capturing and archiving portions of printed publications for electronic searching and retrieval via a computer network;

FIG. 3 is a schematic illustration of various computer applications that may be used to implement the method of FIG. 2;

FIG. 4 is a search page of an exemplary user interface of a computer program of the present invention;

FIG. 5 is the user interface of FIG. 3, illustrating a drop-down window enabling a user to select one of a pre-determined plurality of employment categories to search;

FIG. 6 is the user interface of FIG. 3, illustrating a drop-down window enabling a user to select one of a pre-determined plurality of employment sub-categories to search;

FIG. 7 is the user interface of FIG. 3, with the “engineering” category and the “electrical” sub-category selected;

FIG. 8 is a search results page of the user interface of the computer program;

FIG. 9 is an exemplary employment-related advertisement displayed as part of the search results page of FIG. 7;

FIG. 10 is a page of the user interface allowing the user to save the advertisement of FIG. 8 to an electronic briefcase; and

FIG. 11 is a page of the user interface allowing the user to edit a user profile.

### DETAILED DESCRIPTION OF A PREFERRED EMBODIMENT

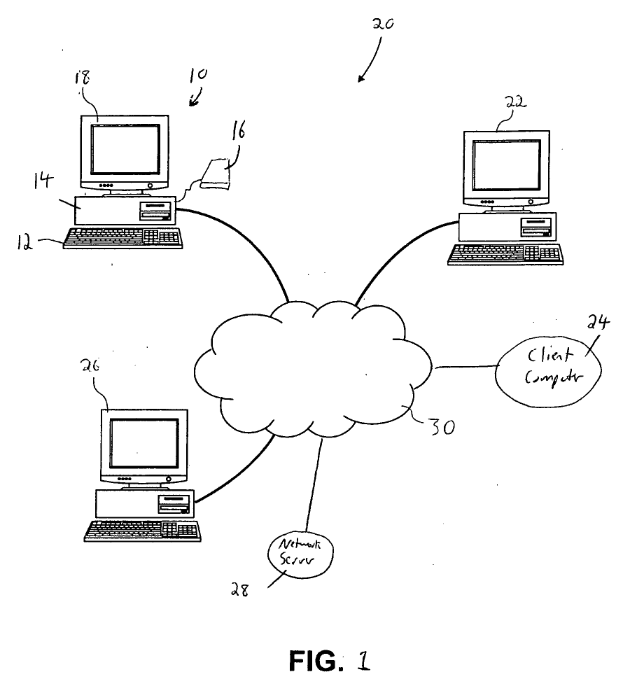

The present invention involves a method and computer program for electronically capturing and archiving portions of printed publications for electronic searching and retrieval via a computer network. The method of the present invention is especially well-suited for implementation on a computer or computer network, such as the computer 10 illustrated in FIG. 1 that includes a keyboard 12, a processor console 14, a scanner 16, and a display 18. The computer 10 may be a part of a computer network, such as the computer network 20 also illustrated in FIG. 1 that includes one or more client computers 10,22,24 and one or more server computers 26,28 interconnected via a communications system 30.

An embodiment of the present invention will thus be generally described herein as a computer program. It will be appreciated, however, that the principles of the present teachings are useful independently of a particular implementation, and that one or more of the steps described herein may be implemented in hardware, software, firmware, or a combination thereof. Furthermore, one or more steps described herein may be implemented without the assistance of a computing device. The computer program and equipment described herein are merely examples of a program and equipment that may be used to implement the present invention and may be replaced with other software and computer equipment without departing from the scope of the present invention.

The computer program of the present invention is stored in or on a computer-readable medium residing on or accessible by a host computer for instructing the host computer to implement the method of the present invention as described herein. The computer program preferably comprises an ordered listing of executable instructions for implementing logical functions in the host computer and other computing devices coupled with the host computer. The computer program can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions.

The ordered listing of executable instructions comprising the computer program of the present invention will hereinafter be referred to simply as “the program” or “the computer program.” It will be understood by those skilled in the art that the program may comprise a single list of executable instructions or two or more separate lists, may be included in a single software application or multiple software applications, and may be stored on a single computer-readable medium or multiple distinct media. For example, an embodiment of the invention will herein be described as comprising multiple software applications that operate substantially independently of one another and that may be installed on separate, geographically-remote computers.

In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CD-ROM). The computer-readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory.

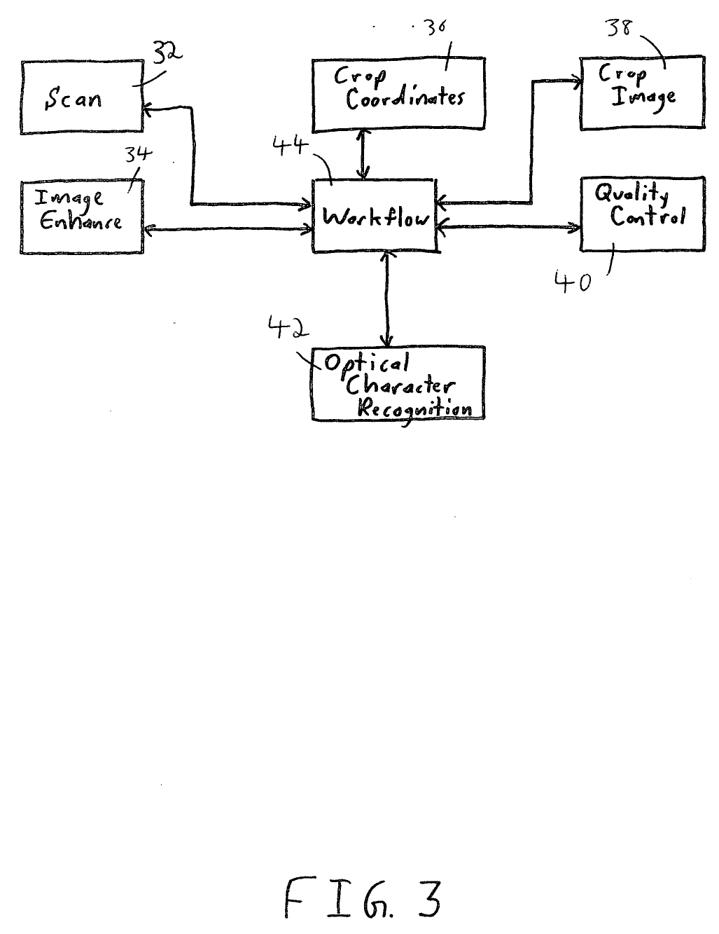

As explained above, the computer program of the present invention may be implemented in one or more standalone computer applications. FIG. 3 illustrates a block diagram of various such computer applications including a scan application 32; an image enhance application 34; a crop coordinates application 36; a crop image application 38; a quality control application 40; an optical character recognition (OCR) application 42; and a workflow application 44. Each of these applications may be implemented on separate computers, or a single computer may implement two or more of the applications. The scan, image enhance, crop coordinates, crop image, quality control, and OCR applications each perform particular functions that are discussed below in greater detail. The workflow application 44 coordinates flow of the overall process by, for example, monitoring a status of each of the other applications and communicating a file from one application to another.

The application scheme illustrated in FIG. 3 are exemplary in nature, and it will be understood by those skilled in the art that two or more of the illustrated applications may be combined and different applications may be used in addition to those illustrated.

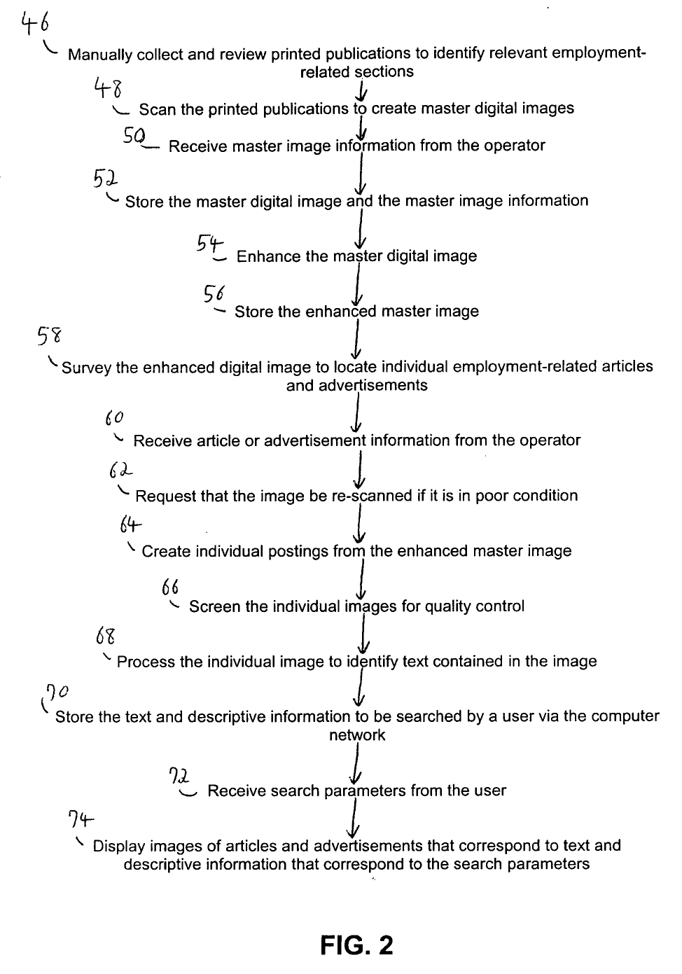

A flowchart of steps involved in an embodiment of the method and computer program of the present invention is illustrated in FIG. 2. Some of the blocks of the flowchart may represent a software object, module segment, portion of code, or standalone application of the computer program of the present invention which comprises one or more executable instructions for implementing the specified logical function or functions. In some alternative embodiments, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved.

First, one or more printed publications are manually collected and reviewed to identify relevant employment-related sections, as depicted in block 46. The printed publications are preferably publications that include content that is not available in electronic form via a computer or computer network and may include, among other things, newspapers, magazines, research journals, trade journals and other trade publications, classified advertisements, fliers, and postings. Such publications may be acquired by purchasing them via a subscription or on an issue-by-issue basis, and the publications may be delivered to one or more central locations for review or may be reviewed in a geographic location of origin of each publication. It may be desirable, for example, to retain the service of an operator in each city where one or more publications are printed and distributed to ensure timely review of each publication.

The publications are reviewed within the context of a particular customer base to identify employment-related sections that are relevant to the customer base. The employment-related sections of the publications that are not relevant to the customer base are physically marked or removed from the publication. In some cases, a publication may contain no relevant content and may be discarded in its entirety. An exemplary customer base includes professionals and recruiters who specialize in placing such professionals, in which case non-professional or “blue collar” job listings may be ignored or discarded. An operator reviewing a section of classified ads or “want ads” from a newspaper may simply draw a line through or otherwise mark each irrelevant ad, as explained above, so that such ads are ignored in subsequent processing steps.

Once the printed publications are collected and manually reviewed to identify relevant employment-related sections, each publication is electronically scanned to create one or more master digital images of the publication, as depicted in block 48. A relevant portion of each publication is manually scanned by an operator using, for example, the scanner 16 connected to the computer 10 of FIG. 1, wherein the computer 10 is running the scan application 32. Each master digital image includes one or more individual employment-related articles or advertisements of the printed publication. As used in this document, an “article or advertisement” is any individual section of a printed publication such as a single article, a single advertisement, a single posting or listing, etcetera, that contains text, graphics, or combination of text and graphics.

A single master digital image may be created for each printed publication, or multiple master images may be created for one or more publications if, for example, a publication has multiple pages with relevant information that must be scanned. Furthermore, the master image or images may be created by combining two or more smaller master images. This and other image manipulation techniques that may be used to create the master image are within the ambit of the invention. Because the pages of some newspapers and other periodicals are significantly larger than a standard 8½×11 inch piece of paper, the scanner 16 is preferably a forty-two inch large-format scanner operable to accommodate an entire newspaper page. Smaller scanners can be used, but may require multiple scans and generate multiple images where a large-format scanner could create a single image from a single scan.

The operator creating the master image views the image on the display 18 of the computer 10 to verify that the image is of acceptable quality. If the operator scanning the image is not satisfied with the appearance of the digital image, he or she may re-scan the image to generate an improved version of the image. The user may discover, for example, that the master image turned out to be darker than anticipated, was blemished by an object on the scanner or the publication, or was not lying flat against the scanner bed.

To simplify the present discussion the method will generally be described hereafter as generating a single master image from a single publication. A preferred implementation of the method, however, involves creating one or more master images for each of a plurality of printed publications, wherein each image is created in a manner substantially similar to the method described herein.

Once the master digital image is created for the printed publication, information relating to the master digital image is received from the operator creating the image, as depicted in block 50. The master image information identifies the publication, publication section, or both, from which the master image was derived, and as such may include a name of the publication, date of the publication, page number, volume and issue number, or similar identifying elements.

The master image and related information are then stored for future processing, as depicted in block 52. These files are preferably stored in a file storage system that is accessible via the network 18 so that various computers on the network 18 may access the files, as explained below in greater detail. Storing the master digital image at this stage enables an operator to retrieve the original master image if subsequent processing produces undesirable results.

The master digital image is then enhanced, as depicted in block 54. In this step, a computer running the image enhancement application 34 enhances the master digital image for clarity to render objects in the image, such as text and logos, more discernable to a person or a machine. The step of enhancing the master digital image involves applying one or more digital filters to the image. Filters applied to the image may straighten, align or rotate the image if it was scanned at an undesirable angle; remove blemishes from the image created by dust particles on the printed publication or the scanning device; modify textual characters so that they appear more crisp or otherwise discernable to a person or a machine; and modify a color scheme of the image to enhance colors or to reduce the number of colors, such as to remove any shades of gray so that the image presents only black and white. These are but a few examples.

In enhancing the master digital image, a single digital filtering scheme may be used wherein the same filters are applied to each master image, or the program may enable an operator to choose one or more filters to apply. In the latter case, if the operator recognizes that the printed publication does not need to be straightened or aligned, for example, the user may choose to not apply a filter to straighten the image. Similarly, if the user recognizes that the textual characters are substantially crisp and discernible, the user may choose not to apply a filter to sharpen the characters. Furthermore, the computer 10 may process the master image to automatically determine which filters, if any, should be applied to the master digital image.

Once the master image has been enhanced, the enhanced image is stored for future processing, as depicted in block 56. As explained above, the enhanced digital image and other files are preferably stored in a file storage system that is accessible via the network 20 so that various computers on the network 20 may access the files. Thus, a user working on a first networked computer 10 in a first geographic location, such as a first city, can scan one or more printed publications available only in that location and save the original master image to the file storage system, and a second user working on a second network computer 22 located in a second geographic location, such as a second city, can access the saved master image to enhance the master image file as explained above and store the enhanced image file to the network storage for further processing by yet another operator who may be located in yet another geographic location.

The enhanced digital image is surveyed by an operator to locate individual employment-related articles or advertisements, as depicted in block 58. In this step, the enhanced digital image is examined by an operator to identify and delineate boundaries of each employment-related article or advertisement included in the image. The image is presented to the operator via a computer display, wherein the computer is running the crop coordinates application 36. The operator electronically indicates a boundary of each article or advertisement by, for example, drawing a line or series of lines around the article or advertisement. The computer 10 may assist the operator by automatically drawing an outline that is a rectangle, triangle, circle, oval or other shape and allowing the operator to place the outline over the target article or advertisement and manipulate a size and shape of the outline to match a shape of the target article or advertisement. The computer uses the outline to generate coordinates relating to the article or advertisement, wherein the coordinates represent locations within the enhanced image. Such coordinates may include two pixels, for example, corresponding to opposite corners of a rectangular box, or two values corresponding to a location of a center of a circle and the circle's radius.

As the operator identifies an individual article or advertisement, he or she also submits information corresponding to that article or advertisement, as depicted in block 60. The article or advertisement information identifies one or more categories to which the article or advertisement belongs, and may include a category and a subcategory. A category may be “accounting” or “engineering,” for example, with engineering subcategories including “mechanical,” “civil,” “software,” and “electrical.” Another category may be “healthcare” with subcategories including “nurse,” “administrator,” “technician,” “therapist,” and “pharmacy.” The coordinate information and the article or advertisement information are stored in the XML file for use with another application or program segment, as explained below.

The steps described above for defining coordinates and submitting information associated with the article or advertisement are repeated for each article or advertisement in the master digital image.

If the operator creating the coordinates determines that the enhanced image is of unacceptable quality, he or she may request that the image be re-scanned, as depicted in block 62. The operator creating the coordinates reads or skims each article or advertisement to assign it one or more categories, as discussed above, and thus may catch imperfections in the enhanced digital image that other operators who don't read each article or advertisement may overlook. If the operator requests a new scan, the coordinate and posting information are not stored in the XML file.

Once the master digital image has been surveyed to identify, locate, and categorize each article or advertisement, individual postings are created from the enhanced master image, as depicted in block 64. In this step, the program parses the XML file to identify each individual employment-related article or advertisement contained in the master image and, using the coordinate information, creates a separate digital image of each individual employment article or advertisement. This step may be performed by the crop image application 38. The images corresponding to individual articles or advertisements may be created by cropping the enhanced image (or an instance of the enhanced image).

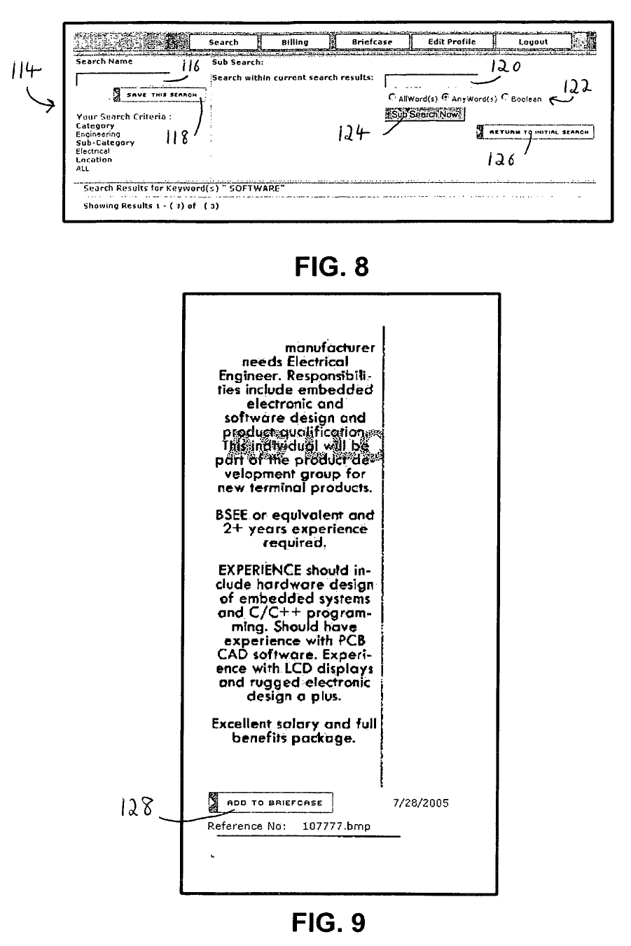

The program creates three copies of each image relating to an individual employment-related article or advertisement. A first copy is substantially identical to the cropped portion of the master image and is used. to generate text data, as explained below in greater detail. Second and third copies are similar to the cropped portion of the master image, but are watermarked for presentation to a user via the computer network 20. The images are watermarked by embedding them with a lightly visible pattern of bits containing information corresponding to, for example, company information, copyright information, or both. An exemplary watermarked image is illustrated in FIG. 8. The second image is substantially the same size as the first image, while the third image is reduced in size relative to the second image for more efficient presentation to a user via the computer network 20.

Once the individual images have been created they are screened for quality control, as depicted in block 66. In this step, the program enables an operator to view and manipulate the individual images. This function can be performed by th equality control application 40. The user can crop an image, for example, to eliminate excess image area, thereby reducing the size of the binary image file. Furthermore, the operator at this point in the process may choose to re-scan the publication or re-crop the master image to generate an improved individual image, such as where a portion of the text was obscured or lost in processing.

When an individual image passes the quality control screening, it is then processed to identify text contained in the image, as depicted in block 68. This is done by processing the first of the three image copies discussed above with optical character recognition (OCR) software that analyzes the image to identify each character that appears in the image as well as relationships between characters to recreate words and sentences. The recreated characters, words, and sentences are stored in a common format, such as ASCII, that may be searched or manipulated by the computer. While OCR may be performed entirely with software, a specialized circuit board may be used to expedite the image processing wherein the circuit board is embedded in the computer 10 in, for example, a PCI card (not shown). Preferably, OCR is performed by the optical character recognition application 42.

The text and category information that is associated with each individual image is made available to be searched via the network by a user for keywords, as depicted in block 56. The program enables the user to restrict the scope of the search by submitting various search parameters, as depicted in block 58. The search parameters include keywords to match in the text; a category and a subcategory of postings to search; a geographic location associated with the posting; and a time period to search. The program performs the search and retrieves the individual postings that correspond to the search parameters, as depicted in block 60.

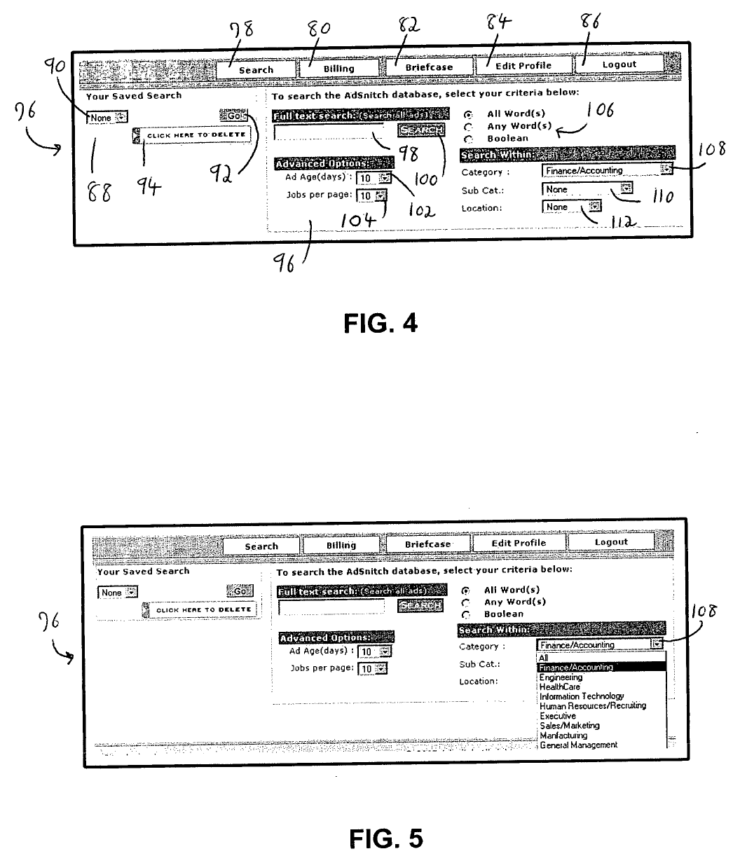

An exemplary user interface is illustrated in FIGS. 4-11, wherein the interface generally enables users to search the information collected for each article or advertisement and view articles and advertisements of interest. When a user first accesses a host website, the site requires the user to submit login information, such as a username and password, in a conventional manner. Upon submitting valid login information, the user is presented with a web page including the search interface 76 of FIG. 4. A panel of buttons is placed near a top of the interface 76 and includes a search button 78, a billing button 80, a briefcase button 82, an edit profile button 84, and a logout button 86. Clicking on the search button 78 causes the interface 76 to appear. The search interface 76 is also the default interface that is presented when a user logs onto the website.

A saved search area 88 is located near a left side of the interface 76. The saved search area 88 includes a drop-down window 90 for allowing a user to select a previously saved search, a go button 92 for returning to the saved search that is indicated in the drop-down window 90, and a delete button 94 for deleting the search that is indicated in the drop-down window 90.

A present search area 96 occupies a larger portion of the search interface 76 and includes a text field 98 and a search button 100 for launching the search according to text submitted by a user via the text field 98 and according to other information submitted by the user. Such other information is submitted by the user via other portions of the present search area 96. An age drop-down box 102 enables a user to choose a maximum age (in days) of the articles or advertisements to select from, wherein the illustrated age is ten days. The age drop-down box 102 includes a variety of other values including values corresponding to relatively short time periods such as five days or fifteen days, and values corresponding to longer time periods, such as two hundred days and three hundred and sixty-five days. Similarly, a jobs-per-page drop-down box 104 enables a user to choose a maximum number of search hits to display on each page.

A set of radio buttons 106 enables a user to determine how the text submitted via the text field 98 will be used to perform the search. The user may require the program to return only those hits that include all of the words of the submitted text or any of the words of the submitted text. Alternatively, the user may require the program to perform a boolean search by, for example, recognizing boolean operators in the submitted text.

The search interface 76 also allows the user to narrow the search by specifying various search parameters. A category drop-down window 108, for example, allows the user to specify a particular category of articles and advertisements to search. Examples of categories that may be available include finance/accounting, engineering, healthcare, information technology, human resources/recruiting, executive, sales/marketing, manufacturing, and general management. FIG. 5 illustrates the drop-down window 108 selected and providing the above-described list of categories. As illustrated, the user may choose to search in all categories.

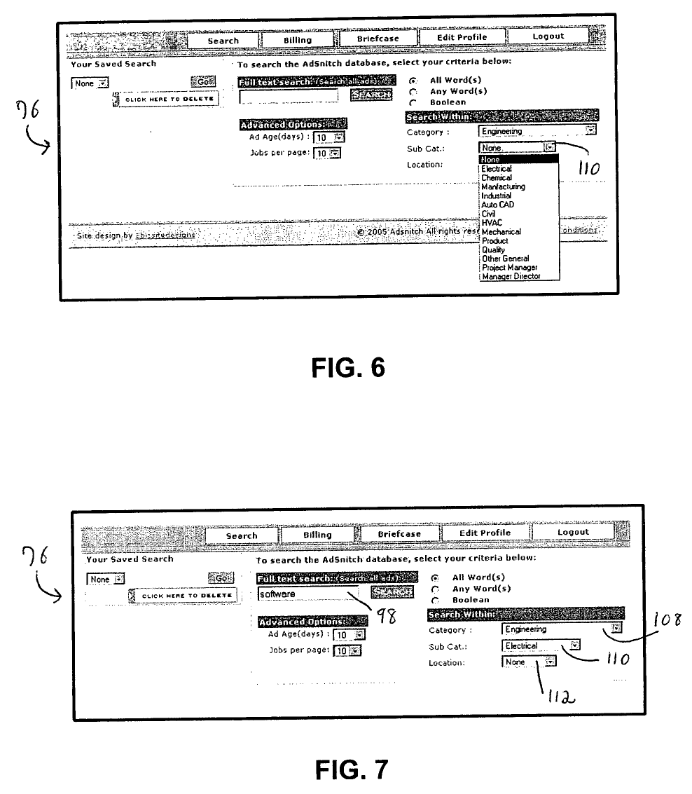

A subcategory drop-down window 110 allows the user to further refine the search by selecting a particular subcategory relating to the category chosen by the user. In the interface of FIG. 6, engineering has been chosen as the category and the subcategory drop-down window 110 has been selected and presents various subcategories corresponding to engineering.

A location drop-down window 112 allows the user to limit the search to articles and advertisements that originate from particular geographic areas of the country such as the Southeast, West, South, Midwest, and Northeast. The user may keep the search broad by selecting “none,” as illustrated in FIG. 7.

When the user has submitted the various search parameters discussed above via the search interface 76, the user selects the search button 100 to launch the search. The program then performs a search of the text extracted from the articles and advertisements according to parameters submitted by the user, such as category and subcategory. After performing the search, the program presents the search results in a search results interface 114 as illustrated in FIGS. 8-9. The search results interface 114 allows the user to save the search and search results by submitting a name of the search in a search name text field 116 and selecting a save search button 118. The search results interface 114 further allows the user to perform a sub-search by submitting text in a sub-search text field 120 and indicating how the text will be used to perform the search via a set of radio buttons 122. Selecting a sub-search button 124 launches the search, and selecting a return to initial search button 126 exits the search results interface 114 and returns to the search interface 76.

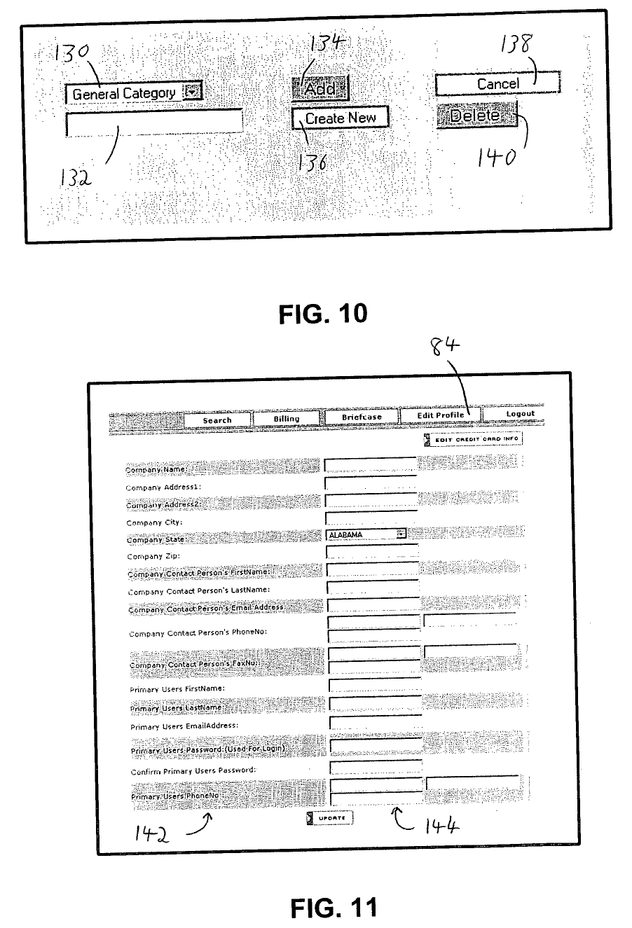

As indicated by text near a bottom of the search results interface 114, the search for “software” in the category of engineering and subcategory of electrical in ads from the last ten days resulted in three hits. FIG. 9 illustrates an exemplary advertisement retrieved by the search. It can be seen that the advertisement is in substantially the same form as it appears in the printed publication. Selecting an add to briefcase button 128 assigns the article or advertisement to an electronic briefcase by generating an add to briefcase dialog window illustrated in FIG. 10. The add to briefcase dialog window includes a drop-down window 130 for selecting a general category of the article or advertisement as well as a search name text field 132 for submitting a name associated with the article or advertisement. Selecting the add button 134 adds the article or advertisement to the briefcase under the submitted name.

Selecting the edit profile button 84 invokes the interface illustrated in FIG. 11, including a column of profile element identifiers 142 and one or more columns of corresponding text fields 144 for submitting values corresponding to the identifiers 142.

Although the invention has been described with reference to the preferred embodiments illustrated in the attached drawings, it is noted that equivalents may be employed and substitutions made herein without departing from the scope of the invention as recited in the claims. It will be appreciated, for example, that the method and computer program of the present invention is not limited to use with employment-related sections of printed publications, but may also be used to electronically capture and store publication information relating to real-estate, vehicles, pictures and other graphics, and so forth.

Having thus described a preferred embodiment of the invention, what is claimed as new and desired to be protected by Letters Patent includes the following:

1. A computer-implemented method of processing images of printed publications, the method comprising the steps of:
scanning a printed publication to create a first digital image of a portion of the publication;
receiving location information from a user identifying a location of an article or advertisement in the digital image;
creating a second digital image from the first digital image, wherein the second digital image corresponds to a portion of the first digital image defined by the location information;
processing the second digital image to generate text data corresponding to text contained in the second image, associating the text data with the second image, and storing the text data and the second image in a database; and
presenting the second image to a user if the text data matches a search parameter submitted by a user.

2. The method as set forth in claim 1, further comprising the step of generating a watermark in the second image such that the watermark is visible to a user.

3. The method as set forth in claim 1, further comprising the step of presenting the first digital image to a user and receiving from the user coordinate information defining a boundary of the article or advertisement.

4. The method as set forth in claim 3, further comprising the step of receiving from the user additional location information identifying locations of a plurality of additional articles or advertisements in the first digital image.

5. The method as set forth in claim 4, further comprising the step of creating a plurality of additional digital images from the first digital image using the additional location information, wherein each of the plurality of additional digital images corresponds to one of the additional articles or advertisements.

6. The method as set forth in claim 5, further comprising the step of processing each of the additional digital images to generate text data corresponding to text contained in the additional image, associating the text data with the additional image, and storing the text data and the additional image in the database.

7. The method as set forth in claim 6, further comprising the step of presenting one or more of the additional digital images to the user if the text data corresponding to the additional image matches the search parameter submitted by the user.

8. The method as set forth in claim 1, further comprising the step of filtering the first digital image to render it more readable by a user and more easily processed by a computer.

9. The method as set forth in claim 1, further comprising the steps of:
receiving category, subcategory, and geographic area information from a user, and
associating the category, subcategory, and geographic area information with the second digital image.

10. The method as set forth in claim 9, further comprising the steps of:
receiving from the user search parameters including a keyword, a category, a subcategory, and a geographic area; and
performing a keyword search of text data taken from the small digital image only if the category, subcategory, and geographic area information of the small digital image matches the corresponding search parameters.

11. A method of electronically archiving employment-related information from a plurality of printed publications, the method comprising the steps of:
reviewing each of the printed publications to identify relevant portions containing employment-related information;
electronically scanning the relevant portions of each of the printed publications to create at least one master digital image associated with each publication;
surveying each master digital image to identify coordinates corresponding to one or more employment-related articles or advertisements contained in the image;
creating a plurality of specific images from each master image, wherein each specific image corresponds to a single article or advertisement defined by the coordinates;
processing each specific image using a computer to generate text data corresponding to text contained in the specific image, associating the text data with the specific image from which it was generated, and storing the text data and the specific images in a database; and
presenting a specific image to a user if the text data corresponding to the specific image corresponds to a search parameter submitted by a user.

12. The method as set forth in claim 11, further comprising the step of identifying a boundary of each article or advertisement contained in the master image and using the boundary to generate the coordinate information.

13. The method as set forth in claim 11, further comprising the step of collecting the printed publications from a variety of different geographic locations by sending the publications to a central location.

14. The method as set forth in claim 11, further comprising the step of reviewing and electronically scanning each of the printed publications in different geographic locations and electronically communicating the master digital images to a central location for surveying.

15. A computer-readable medium encoded with a computer program for enabling a computer to process images of printed publications, the computer program comprising:
a scanning routine for generating a new master image of a printed publication by scanning a portion of the printed publication;
an image enhancing routine for processing the new master image to generate an enhanced master image that is more easily read by a person and more easily processed by a computer, and for storing the enhanced image in a digital storage medium;
a crop coordinates routine for presenting the master digital image to a user and receiving from the user coordinate information identifying a plurality of articles or advertisements contained in the master image;
a crop image routine for generating a specific image corresponding to the plurality of articles or advertisements contained in the master image according to the coordinate information;
a character recognition routine for generating text data corresponding to text contained in the specific image and associating the text data with the specific image from which it was generated; and
a workflow routine for automatically communicating the new master image generated by the scanning routine to the image enhancing routine, for automatically communicating the enhanced image to the crop coordinates routine, for automatically communicating the enhanced image and the coordinate information to the crop image routine, for automatically communicating the specific image generated by the crop image routine to the text processing routine, and for automatically storing the specific image and the associated text data generated by the character recognition routine in a searchable database.

16. The computer-readable medium as set forth in claim 15, further comprising a quality control routine for enabling a user to review a portion of the one or more specific images generated by the crop image routine, wherein the workflow routine automatically communicates a portion of the one or more specific images generated by the crop image routine to the quality control routine.

17. The computer-readable medium as set forth in claim 15, further comprising a search routine for enabling a user to perform a keyword search of the searchable database, and for presenting a specific image that corresponds to a keyword submitted by the user.

18. The computer-readable medium as set forth in claim 15, wherein the crop coordinates routine further enables a user to delineate a boundary of each article or advertisement and generates the coordinate information from the boundary created by the user.
